(19) United States
(12) Patent Application Publication
(10) Pub. No.: US 2003/0145017 A1
(43) Pub. Date: Jul. 31, 2003

(54) Method and application for removing material from documents for external sources

(76) Inventors: Thadd Clark Patton, Mason, OH (US); Mark Creekmore JR., Lebanon, OH (US)

Correspondence Address: GENERAL ELECTRIC COMPANY, ANDREW C HESS, GE AIRCRAFT ENGINES, ONE NEUMANN WAY M/D H17, CINCINNATI, OH, 452156301

(21) Appl. No.: 10/062,819

(22) Filed: Jan. 31, 2002

(51) Int. Cl. G06F 17/00

(52) U.S. Cl. 707/104.1; 715/500

(57) ABSTRACT

An application is used for eliminating or removing from documentation particular portions of text and/or drawings that include technical data or information that is not to be made available to persons outside of the U.S. without established license or legal agreements. After editing, the content of the documentation does not include references to restricted military programs, restricted technologies under U.S. Government export controls, a company's controlled technologies and a third party's intellectual property information. The application can assist a user in identifying restricted information, inserting proper document marking or data tagging and executing appropriate web-processing to create documentation for global distribution that is compliant under U.S. Government export control regulations and under the company's own general proprietary information and technical agreements.

### BACKGROUND OF THE INVENTION

The present invention relates generally to a method and application for an internal source to remove material from a document that is to be distributed to an external source. More specifically, the present invention is directed to a method and application for “sanitizing” a document by eliminating or removing restricted military and commercial export controlled information and/or company or organizational specific intellectual property information from the document, in order to identify and provide selected portions of the document to an external source under appropriate legal conditions.

Frequently, a company or organization driven by the demands of doing business on an international scale may want to utilize an external or global source to complete engineering analysis and design projects. The external or global source can be located within the United States, but, many times, can be located outside of the United States. The decision to use an external source may be based on economic considerations, on the expertise of the external source, or for any other of a number of reasons. While an increase in the quantity of engineering analysis and design projects that are being transferred to external or global sources by a company or organization can result in increased engineering productivity, it also creates additional administrative and logistical burdens.

The U.S. Government has established many regulations, controls and policies concerning the transfer of military and commercial technical information to foreign persons, foreign corporations and foreign governments. Some of these regulations, controls and policies can be referred to as export controls and are implemented to restrict or limit the access by foreign or unauthorized persons to technical data or other important information. In addition, a company or organization may also have its own internal procedures and policies to prevent the company's own intellectual property and proprietary information from being provided to a foreign or unauthorized person. An example of a company intellectual property policy is that a company will only provide or share information with an external source on a “need-to-know” basis per legal business arrangements.

When a company uses an external source for an engineering project, especially an external source that is a foreign person or foreign company, the company has to ensure that any information or technology that is provided to the external source is in compliance with the export controls of the U.S. government and with the company's own internal intellectual property policies. To ensure compliance with export controls and intellectual property policies, a company often implements appropriate procedures and policies to limit the access of information to foreign and other persons. The policies and procedures for complying with export controls and intellectual property policies can include steps of preparing a document with all technical and proprietary information removed and conducting a review of the prepared document.

Current processes for sanitizing documents for external sources have involved the preparation of sanitized documents exclusive to each individual external source. These processes results in the creation of new sanitized documents each time documents are to be sent to an external source, even though the base document may be the same for the external sources. In addition, under the current processes there is a high probability of unauthorized disclosure of restricted information due to inconsistencies in document preparation and review. Other drawbacks of the current processes include a possibility of incomplete information content provided to each external source, a lack of version control over documentation, and a duplication of review efforts on multiple sanitized versions of the same document that can result in a loss of productivity.

One example of a technique that attempts to manage removal of sensitive information from a message is shown in U.S. Pat. No. 5,960,080 (the '080 patent). The '080 patent is directed to a technique for removing sensitive information from a message by replacing the sensitive information with a generic token to generate a sanitized message that can be processed by an unsecured source. The sensitive information removed from the message includes names, addresses, dates, times and numbers contained in the message. The removed sensitive information is then stored in a file and transmitted to the final, external, recipient of the message using secure and trusted sources and techniques after the unsecured interim source has finished their processing of the sanitized message. The sensitive information that was previously removed is then combined with the sanitized message at the external recipient's location to recreate a secured and processed version of the original message. In this arrangement, the sanitized message can be provided to an unsecured or untrusted external source, such as foreign language translator, for processing or servicing because all sensitive information has been removed from the sanitized message.

The technique in the '080 patent is useful in ensuring the security of sensitive information included in a message as it is processed, in the interim, by an unsecured external source prior to being transferred to a final secured external recipient. However, the '080 patent does not address the removal of technical information or intellectual property information included within the message as intended for distribution to the final external recipient because the sensitive information that was removed from the message for the untrusted source is re-inserted into the message for the final external source. In the '080 patent, an unsecured or untrusted source is used as a interim processing medium for content that is not to be shared outside of the initial and final parties. In addition, the technique in the '080 patent results in the removal of sensitive information each time a message is sent to a recipient, which results in some of the drawbacks discussed above including possible disclosure of unauthorized information and duplication of the review process.

Therefore, what is needed is an application and process that is available company-wide to assist an authorized user or author to electronically create, store, and edit documentation that is fully compliant with U.S Government and other company or organizational recognized legal restrictions such as all export controls and intellectual property policies, for distribution to authorized external or foreign sources.

### SUMMARY OF THE INVENTION

One embodiment of the present invention is directed to a method of generating a sanitized document. The method comprises obtaining a document that includes a plurality of types of information. Next, the document is reviewed to identify a preselected type of information in the document. The identified preselected type of information is then marked in the document to generate a marked document. The marked identified preselected type of information in the marked document is distinguishable from other types of information in the marked document. An application is executed on the marked document to generate a sanitized document and a log file. The marked identified preselected type of information is removed from the sanitized document and is included in the log file. The marked document, the sanitized document and the log file are stored in a database accessible by a plurality of users to provide the marked document, the sanitized document and the log file to internal and external sources per individually determined user and group defined access permissions.

Another embodiment of the present invention is directed to a computer program product embodied on a computer readable medium and executable by a computer for generating a sanitized document. The computer program product comprising computer instructions for executing the step of obtaining of a draft document. The draft document includes both restricted information and unrestricted information. The computer program product also includes computer instructions for reviewing the draft document to identify the restricted information in the draft document and for tagging the identified restricted information in the draft document to generate a tagged document. The tagged restricted information in the tagged document is distinguishable from the unrestricted information in the tagged document. The tagged document is then processed to generate a sanitized document and a log file from the tagged document. The sanitized document includes the unrestricted information and the log file includes the tagged restricted information. Finally, the tagged document, the sanitized document and the log file is stored in a database. The tagged document, the sanitized document and the log file stored in the database are accessible by a plurality of users to provide to an external source.

Still another embodiment of the present invention is directed to a system for generating a sanitized document. The system includes a server computer having a storage device and a processor and a database being accessible by the server computer. The system also includes a sanitization application to remove preselected information from a document for an external source. The sanitization application is stored in the storage device of the server computer. The sanitization application further includes means for editing the document to designate the preselected information in the document, means for generating an issued document from the edited document, means for generating a sanitized document from the edited document, means for generating a log file from the edited document, and means for retrieving the sanitized document and the log file from the database. The issued document is stored in the database and includes both marked preselected information and other information. The sanitized document is stored in the database and omits the marked preselected information. The log file is stored in the database and includes the marked preselected information. The retrieved sanitized document and log file are providable to an external source. Finally, the system also includes at least one client computer in communication with said server computer. The sanitization application is accessible on said at least one client computer.

One advantage of the present invention is that a document is created that can be freely provided to multiple external or global sources under the least common denominator, or the least restrictive export control, intellectual property or other legal condition.

Another advantage of the present invention is that sanitized documents are stored in a central location and can be provided to authorized global or external sources without the need to re-sanitize the document, which results in document consistency because the identical sanitized document is being provided to multiple external sources.

Still another advantage of the present invention is that restricted material removed from the external documentation is consistently identified and maintained within the internal documents, thereby providing only one sanitized version of each internal document.

Yet another advantage of the present invention is that productivity is improved because internal documents have to be reviewed only a single time and then sanitized documents can be sent to authorized external sources as necessary.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 illustrates schematically an overview of the development and handling of sanitized documents.

FIG. 2 illustrates a flow chart for sanitizing a document.

FIG. 3 illustrates a flow chart of the process of step 204 of FIG. 2.

FIG. 4 illustrates a flow chart of the process of step 206 of FIG. 2.

FIG. 5 illustrates a flow chart of the process of step 208 of FIG. 2.

FIG. 6 illustrates a flow chart of the process of step 210 of FIG. 2.

FIG. 7 illustrates a document to be sanitized as seen by an internal author sanitizing or editing the document.

FIG. 8 illustrates the sanitized document as seen by other authorized internal users.

FIG. 9 illustrates the sanitized document as seen by the authorized global source or external user.

FIG. 10 illustrates a log file of the sanitized document with the material removed from the sanitized document as seen by authorized internal users.

Whenever possible, the same reference numbers will be used throughout the figures to refer to the same parts.

DETAILED DESCRIPTION OF THE INVENTION

The present invention is directed to an application for assisting a user with the creation, editing, and storing of sanitized documents, i.e. documents where all restricted technical data and information have been removed. Preferably, the sanitization application is used by internal source engineers to prepare sanitized documents for use by authorized external sources associated with an engineering project. However, the present invention can be used to sanitize any type of document that includes identifiable restricted technical data or information for export or transfer of the document to external sources or foreign persons. An export is the actual shipment, transmission, or transfer of items (including military or commercial technical data and information) out of the United States or to foreign persons, whether in the United States or abroad, by any means. A foreign person is any person who is not a United States citizen, not a United States permanent resident (i.e. a green card holder), or not a protected individual under the Immigration and Naturalization Act. This includes foreign corporations (i.e., those not incorporated in the United States) and foreign governments or any subdivisions or agencies of foreign governments. A company's employees can also be foreign persons regardless of their employment status.

The sanitization application can be used to create and store a master or original document in a central location for access by all authorized internal users. In addition, the sanitization application can also be used to remove restricted information, technical data and proprietary information from a master document, regardless of whether the master document is newly created or had been previously created and stored in a central location. When information and data is removed from a master document, a sanitized document and a document log file is generated by the sanitization application. The sanitized document and document log file are also stored in a central location for access by all authorized internal users.

The marked preselected information in the master document, when viewed by internal or company users, is identical to the original or master document, except that the information designated for removal from the original or master document is distinguished from the remaining text and/or graphics. In contrast, when viewed by an external or global source, the sanitized document does not include any of the information designated for removal from the original or master document. The document log file includes the information that was designated for removal from the original or master document. The log file can be viewed by authorized internal users to confirm what information has been removed from the document or to determine if specific contents of the log file can be provided to an external source under more restrictive export control licenses or appropriate legal arrangements. After making a determination to provide specific content included within the log file to an external or global source and taking some additional steps to ensure that appropriate security and authorization procedures have been followed, the specific content included within the log file can be transferred to the external or global source following the more restrictive U.S. Government export control license or company or organizational legal arrangements.

In another embodiment of the present invention, the sanitization application can be incorporated as a component of a larger application that is executed within the larger application. The sanitization application can again be used to create, edit, and store sanitized documents, however, the generation, editing and storing of sanitized documents is now included as a portion of the larger application. The sanitization application's generation and storage of documents and files is accomplished in a manner that can be interpreted and understood by the larger application.

In a preferred embodiment of the present invention, the sanitization application is implemented as a program or application or a series of programs or applications on a computer network that are executed in a web browser of the user or engineer. The sanitization application can be executed on the client-side, the server-side or on both the client-side and the server-side. Preferably, the sanitization application is stored on a server computer and then accessed by authorized users on client computers. The sanitization application also has one or more databases that are used to store the master documents, the sanitized documents and the document log files. The databases are also preferably stored on the server computer and accessed by the authorized users on the client computers. In another embodiment, each client computer on the computer network may store an individual copy of the sanitization application and the corresponding databases for the individual sanitization applications can be stored on either a server computer or one or more of the client computers that are accessible by each authorized client computer.

The computer network is preferably an Intranet, however any other type of network can also be used, for example, the Internet, a local area network (LAN), a wide area network (WAN) or an Extranet. The client computer and server computer can be any type of general purpose computer having memory or storage devices (e.g. RAM, ROM, hard disk, CD-ROM, etc.), processing units (e.g. CPU, ALU, etc.) and input/output devices (e.g. monitor, keyboard, mouse, printer, etc.). The general purpose computer may also have communication devices (e.g. modems, network cards, etc.) for connecting or linking the general purpose computer to other computers.

In another embodiment of the present invention, the sanitization application can be executed without any requirement for a computer network or network connection. The sanitization application can be executed from an internal memory or storage device, e.g. RAM, ROM, hard disk, etc., of the computer of the user in either a web browser as discussed above or in an operating system environment, such as a Windows environment, a Linux environment or a Unix environment. The sanitization application can be loaded into the internal memory of the authorized user's computer from a portable medium such as a CD-ROM, DVD-ROM, floppy disk, etc., that is inserted into the computer. Alternatively, the sanitization application can be transferred or loaded directly into the internal memory of the authorized user's computer through an electronic connection with another computer that has a stored copy of the sanitization application. In other words, the sanitization application can be downloaded to the authorized user's computer from another computer over a network connection or an Internet connection and can then be operated without the network connection. The user is able to use the sanitization application without a network connection and is able to store the master documents, sanitized documents, document log files and related information and documents in a database. However, for other users to be able to have access to the master documents, sanitized documents, document log files and related information and documents, the user has to reestablish a network connection and upload any master documents, sanitized documents, document log files and related information and documents into the common central database(s) that can be accessed by all authorized users.

One type of document that is frequently used in engineering projects is a design practice. A design practice (DP) includes the documentation of proven design practices based on widely applied technology and experience in the company or organization. A design practice can include mandatory design and evaluation criteria/requirements, design approaches, analytical methods and/or references to sources, limits and other related information. In a preferred embodiment of the present invention, portions of the information contained within DPs are required for use by authorized users in engineering projects at both the internal and external sources and locations. It is to be understood that the use of design practice (DP) in this specification is not intended to be limiting, but is intended to include and refer to all types of documents.

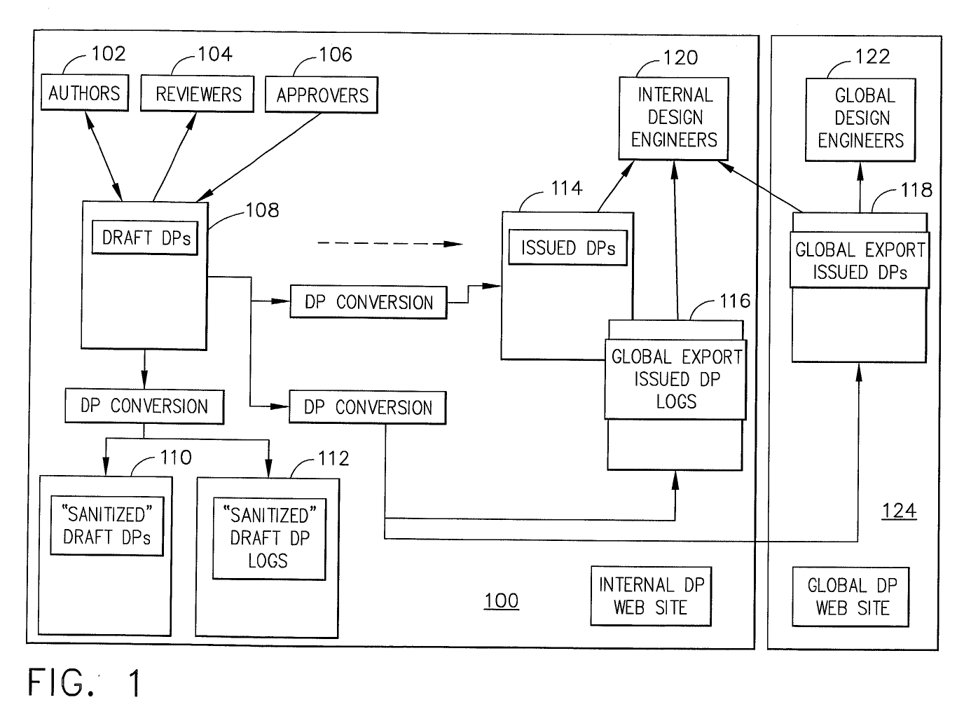

A schematic drawing illustrating the development and availability of a sanitized document or design practice (DP) is shown in FIG. 1. An author 102 can access the sanitization application from an internal network or web site 100 to begin the development of a new draft DP 108. Alternatively, the author 102 can load or retrieve a previously created draft DP 108. Preferably, the draft DP 108 is in a word processing file format such as Microsoft Word, Corel WordPerfect or any other suitable word processing format. The draft DP 108 can be converted using the sanitization application and the process described in greater detail below, to a “sanitized” draft DP 110 and a “sanitized” draft DP log 112. The “sanitized” draft DP 110 and the “sanitized” draft DP log 112 are preferably generated in a portable file format that is read-only, such as Adobe's portable document format (.pdf) or any other suitable file format.

In sanitizing the draft DP 108 to generate the “sanitized” draft DP 110 and the “sanitized” draft DP log 112, the author 102 has marked for elimination or removal from the draft DP 108, particular portions of text, tables, equations, graphics, drawings, etc. that include restricted information, technical data, process knowledge, controlled technologies or business intellectual property information. Technical data, as defined by U.S. Government export control regulations, can be information, when viewed on its own or in combination with other provided information, that is required for or would assist another in the design, development, production, manufacture, assembly, operation, repair, testing, maintenance or modification of commercial commodities or defense articles. This includes information in the form of drawings, blueprints, photographs, plans, instructions, and documentation whether written or recorded on some other media devices. A controlled technology is information and data identified by a company or organization, used in design, production, or service of a component which is critical to its superior performance, to quality, to a low-cost or to a unique company capability. Finally, restricted information can include technical data or process knowledge applicable or subject to U.S. Government export control regulations, U.S. military programs, and the company's or a third party's intellectual property policies that is not be made available to external sources, users, or foreign persons without established license or legal agreements.

The draft DP 108, the sanitized draft DP 110 and the sanitized draft DP log 112 can be reviewed by reviewers 104, which can include author 102, and then approved by approvers 106, which can include author 102 and reviewers 104. Once the draft DP 108, the sanitized draft DP 110 and the sanitized draft DP log 112 have been approved by approvers 106, the draft DP 108 is then converted into an issued DP 114 that operates as a master document, a global export issued DP log 116 and a global export issued DP 118. The issued DP 114 is preferably converted into a HTML format or a read-only, portable file format, e.g. PDF. The global export issued DP log 116 and the global export issued DP 118 are preferably converted into a read-only, portable file format, e.g. PDF. The global export issued DP log 116 includes a record of restricted information or content that has been removed from the global export issued DP 118 and was present in the issued DP 114. Each global export issued DP 118 has its own global export issued DP log 116. An empty global export issued DP log 116 will occur when no restricted information is identified for removal from the issued DP 114. An empty global export issued DP 118 will occur when the entire contents of an issued DP 114 is considered restricted information.

The issued DP 114 and the global export issued DP log 116 are available on the internal network 100 to authorized internal engineers or users 120. The global export issued DP 118 is available to authorized internal engineers 120 and authorized global or external engineers or users 122 from a web site 124 that is accessible by both internal engineers 120 and global engineers 122. For example, the web site 124 can be part of an Extranet that can be accessed by both internal engineers 120 and global engineers 122. However, while authorized internal engineers 120 can have access to all global export issued DPs 118 on web site 124, the global engineers 122 are preferably limited to being able to access only global export issued DPs 118 that have been designated or assigned to the authorized global engineer 122 on web site 124.

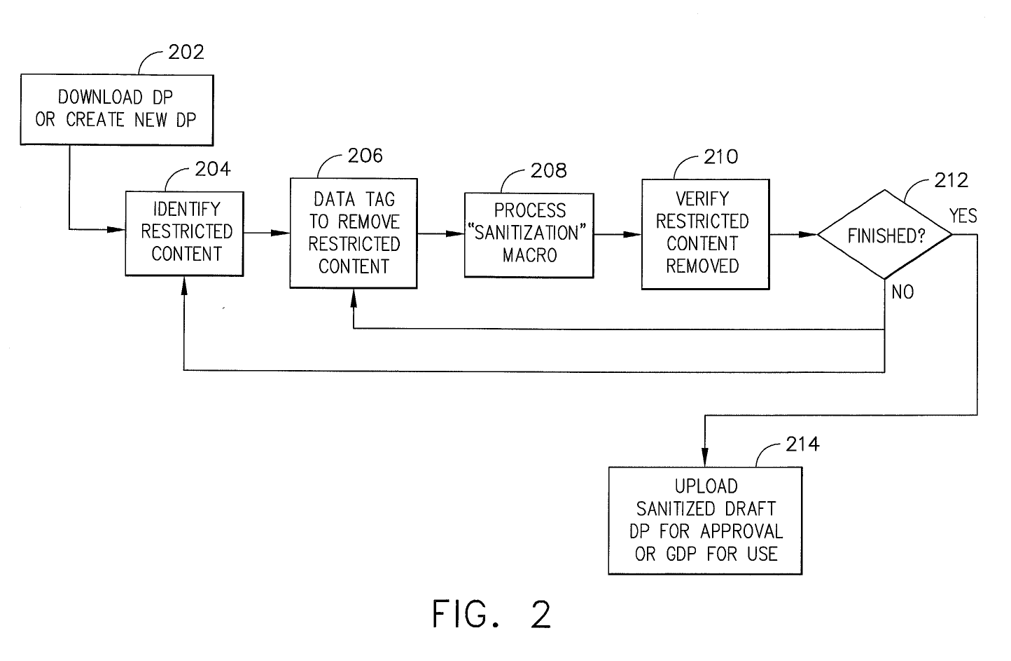

FIG. 2 illustrates the basic process for creating a sanitized document. The process begins at step 202 with the author 102 downloading, from a central location, a draft DP 108 that had been previously created by the author 102 creating a new draft DP 108. Next, in step 204, the author 102 identifies any restricted content or information in the draft DP 108. After the restricted content has been identified in step 204, the author 102 marks or tags the restricted content for removal from the draft DP 108 in step 206. In step 208, a macro, procedure or sub-application in the sanitization application is executed to remove the restricted content or information from the draft DP 108 that was tagged in step 206. The sanitization application creates the sanitized draft DP 110 and the sanitized draft DP log file 112 from draft DP 108 for review by the author 102. The author 102 verifies that the restricted content has been removed from the draft DP 108 and reviews the sanitized draft DP 110 in step 210. In step 212, the author 102 determines if the draft DP 108, the sanitized draft DP 110 and the sanitized draft DP log file 112 are ready for review by reviewers 104 and approvers 106 or for upload to the database for use by internal engineers 120. If the draft DP 108, the sanitized draft DP 110 and the sanitized draft DP log file 112 are not ready for review, approval or upload, the author 102 either returns to step 204 and continues to identify restricted content in the draft DP 108, or returns to step 206 and continues to tag or mark restricted content in the draft DP 108. If the draft DP 108, the sanitized draft DP 110 and the sanitized draft DP log file 112 are ready for approval, the author 102 provides the approver 106 with the draft DP 108, the sanitized draft DP 110 and the sanitized draft DP log file 112 for approval in step 214. After the approver 106 approves the draft DP 108, the sanitized draft DP 110 and the sanitized draft DP log file 112, the issued DP 114, the global export issued DP log 116 and the global export issued DP 118 are generated and stored in the central database using a process similar to that described above for creating the sanitized draft DP 110 and the sanitized draft DP log 112 from draft DP 108 with the sanitization application. After approval by approvers 106, in step 214, the issued DP 114, the global export issued DP log 116 and the global export issued DP 118 are available to authorized internal users 120 on web site 100, while the global export issued DP 118 is available to authorized global engineers 122 on web site 124.

In a preferred embodiment of the present invention, the process of FIG. 2, including the editing and sanitization of the draft DP 108, is completed by an author 102 familiar with the content and purpose of the draft DP 108. By being familiar with the content and purpose of the draft DP 108, the author 102 is better able to identify restricted information and content, and sections of the draft DP 108 that are considered to be regulated by U.S. Government export control regulations or unique to the company or organization's design, quality capability or intellectual property.

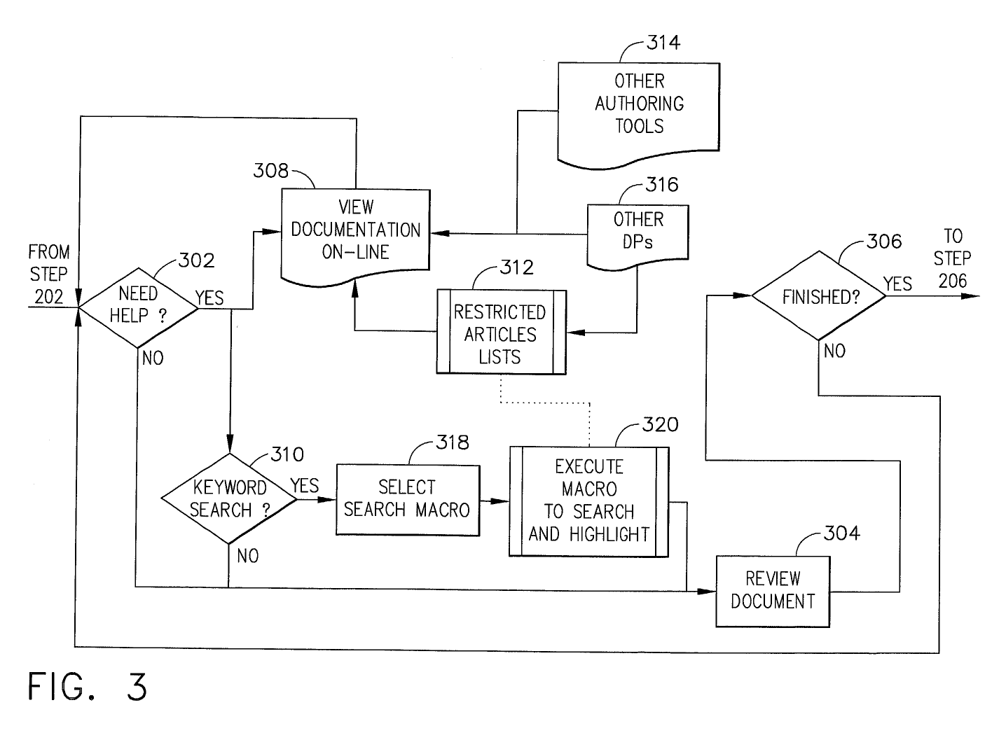

FIG. 3 illustrates a flow chart of the process of identifying restricted information from step 204 of FIG. 2. To begin, after accessing or creating the draft DP 108 in step 202, the author 102 determines if help or assistance is needed in identifying the restricted content in step 302. If the author 102 does not require help in identifying restricted content, the author 102 can manually review the document for restricted content in step 304. After the document has been reviewed in step 304, the author 102 determines if the review process is finished in step 306. If the review process is completed and the document does not require any additional reviewing, the author 102 can begin to tag or mark the restricted content for removal in step 206. Otherwise, the author 102 returns to step 302 to again determine if help is required in identifying restricted content.

If help is desired in identifying restricted content in step 302, the author 102 can either view documentation online in step 308 or can make a decision on executing a keyword search of the document in step 310. When the author 102 views documentation online in step 308, the author 102 can review lists of restricted articles and keywords 312 and information on restricted content from other authoring tools 314 or other design practices 316. After the author 102 has finished viewing the online documentation in step 308, the author 102 returns to step 302 to determine if more help is required in identifying restricted content.

The author 102 can also obtain help in identifying restricted content by making a decision on executing a keyword search in step 310. If the author does not desire to execute a keyword search, the author can review the document in step 304. However, if the author 102 desires to execute a keyword search on the document, the author 102 has to select the appropriate tool, macro or sub-application from the sanitization application in step 318. In step 320, the author 102 executes the sub-application or macro to identify the keywords in the document. The procedure for identifying keywords includes a search of the document for keywords and then highlighting those located keywords in the document. After the search and highlighting of keywords in the document is completed in step 320, the author 102 can review the document or the draft DP 108 in step 304.

To perform character or text searches on the document or draft DP 108, the author 102 has to access the search macro or sub-application of the sanitization application in step 318. The author 102 then enters a search term or terms as the search parameters. The author 102 can also have other options available to further define and refine the scope of the search. The author 102 can select an option to locate text in the draft DP 108 that has a “matching case,” i.e. the text in the draft DP 108 that uses capital letters in the same locations as the search term(s). The author 102 can also select a “matching exact word” option, thereby locating text in the draft DP 108 that is exactly identical to the search term(s). In preparing to execute the search in step 320, the author 102 may access a list 312 of terms and articles that are related to the subject matter of the draft DP 108 for assistance in the selection of the search terms to be used in the search.

In another embodiment of the present invention, the author 102 can also perform character or text searches, which are described in steps 318-320, on the “sanitized” draft DP 110 in its portable or read-only format, e.g. in its PDF format, rather than on the draft DP 108 in its word processing format, e.g. in its Word format. By conducting the text search on the “sanitized” draft DP 110, the author 102 can review the content of the “sanitized” draft DP 110 one more time before it is released for approval in step 214.

Preferably in step 304, the author 102 will read the draft DP 108 in its entirety first to understand the overall intent of the draft DP 108, and where sections of its content are cross-referenced, before beginning the task of identifying restricted information. Next, in reviewing the document, the author 102 should consider all references to U.S. Government export controlled military or commercial restricted content or information including technical data and details regarding: assembly, design, development, engineering, inspection, maintenance, manufacture, modification, production, processing, operation, overhaul, performance, reconstruction, repair, testing, use, etc., for removal from the document or draft DP 108. However, there are situations where references to technical data, information and details are not considered to be export controlled under U.S. Government regulations and may be retained in the global export issued DP 118. The global export issued DP 118 is issued and exported under U.S. Department of Commerce export license exception, No License Required (NLR). The NLR exception is an example of an export license exception permitted under U.S. Government Department of Commerce regulations.

Some examples of technical data that are not considered restricted content include: technical data that provides only a description, general characteristics and expected performance; technical data which does not exceed that normally included in sales brochures, marketing data sheets or similar products that are readily available to the public (including competitors) at trade shows or other public events; and technical data that is composed of general scientific or engineering principles commonly taught in schools, colleges, universities or is in the public domain, e.g. information which is published and totally accessible or available to the public.

In addition to identifying technical data and details, the author 102 has to review the document in step 304 to protect the proprietary information of the company and others from unauthorized disclosure. Proprietary information includes information in which its owner claims a property right to the exclusion of others. It includes technical and business information that gives the owner an opportunity to obtain an advantage over others, such as competitors or potential competitors, who do not have it, or that would adversely affect the position of the owner if made available to others. The author 102 in sanitizing a document has to identify and then mark or tag any proprietary information of the company or of others to prevent disclosure of that proprietary information. Only proprietary information that has been authorized by its owner for disclosure to all global or external sources should be included by the author 102 in the “sanitized” draft DP 110 and eventually in the global export issued DP 118.

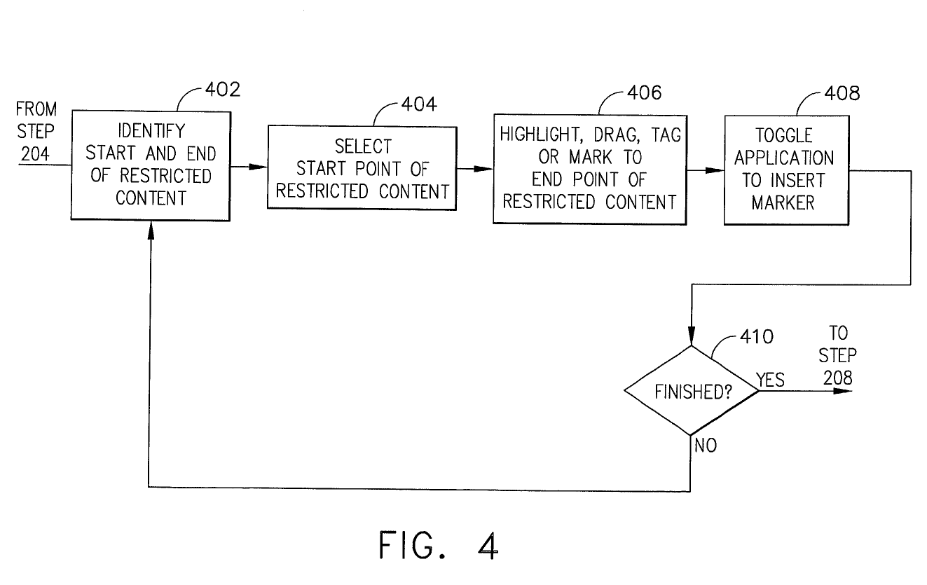

FIG. 4 illustrates a flow chart of the process of tagging or marking the restricted information for removal in step 206 of FIG. 2. To begin, after the document has been reviewed to identify restricted content in step 204 using the procedure in FIG. 3, the author 102 identifies the specific starting and ending points of restricted content in the draft DP 108 in step 402. Preferably in step 402, the author 102 reads the draft DP 108 one paragraph or graphic at a time and then compares the content included in the paragraph or graphic to that content identified in step 204 and conservatively identifies the starting and ending points of any restricted content, preferably erring on the side of identifying the content of the paragraph as restricted content, if questionable.

The particular manner in which the author 102 eliminates or removes restricted content is a decision based on the sentence structure and context of the restricted content in the draft DP 108. First, the author 102 can have the complete removal of restricted content from the draft DP 108 and then collapse any spaces between the text or graphics. Alternatively, the author 102 can have the complete removal of restricted content from the draft DP 108, the collapsing of any spaces, and the insertion of a marker such as the word “deleted” in place of the text or graphic content removed.

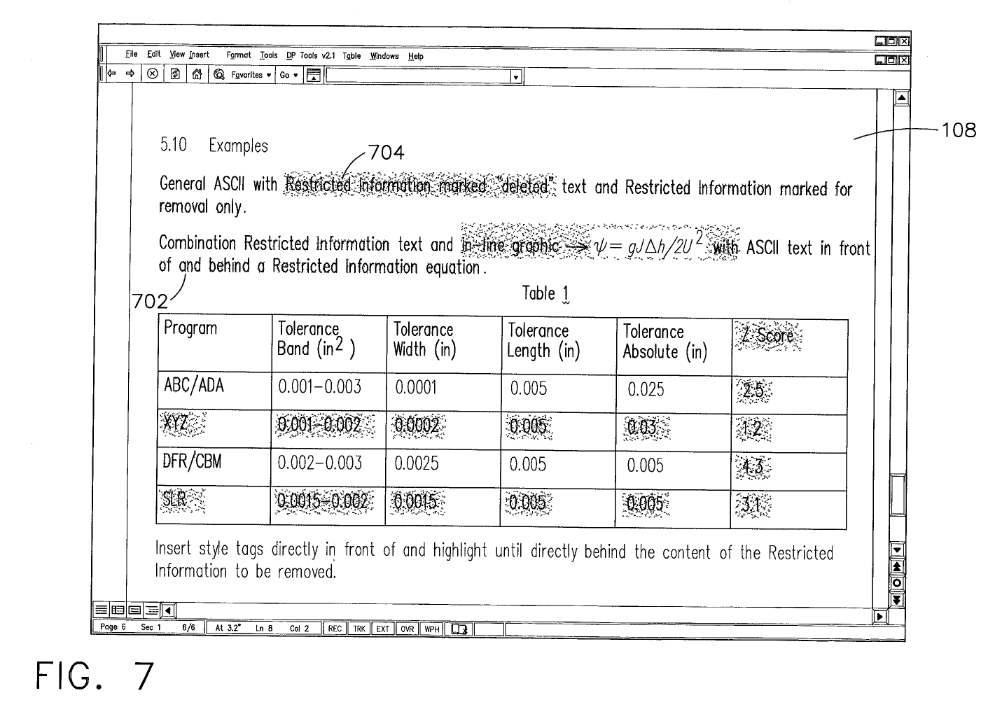

In step 404, the author 102 marks or tags the starting location of the restricted content identified in step 402 within the document or draft DP 108. In step 406, the author 102 then highlights, marks or tags to the ending location of the restricted content to be removed from the draft DP 108. In step 408, the author 102 designates how the removed content from draft DP 108 will be presented in issued DP 114 and eventually in global export issued DP 118 through the use or non-use of a marker. An example of the markings within the draft DP 108 is illustrated in FIG. 7.

If the author 102 decides to include a marker indicating the removal of material in the global export issued DP 118 in step 408, the author 102 toggles the sanitization application (or confirms that the sanitization application has been toggled) at step 408 to have the sanitization application insert the marker at the location where the restricted content has been removed. Alternatively, if the author 102 decides not to include a marker in the global export issued DP 118 in step 408, the author 102 toggles the sanitization application (or confirms that the sanitization application has been toggled) at step 408 to have the sanitization application omit the marker from the location where the restricted content had been removed.

In steps 404-406, the author 102 has to highlight or tag the starting and ending locations within the draft DP 108 of the restricted content to be removed. One way for the author 102 to highlight the restricted content for removal is to highlight the material in the draft DP 108 in a preselected color. When the highlighted draft DP 108 is processed in step 208, the “sanitization” macro or program recognizes the preselected color and removes the restricted content based on that preselected color. If the author 102, has toggled the sanitization application to include markers in step 408, then the restricted content is highlighted in a preselected color that signals the “sanitization” macro to remove the restricted content and insert the marker. Similarly, if the author 102, has toggled the sanitization application to omit markers in step 408, then the restricted content is highlighted in a different preselected color that signals the “sanitization” macro to remove the restricted content without the insertion of a marker. In another embodiment of the present invention, the author 102, can toggle the inclusion of a marker by selecting an appropriate preselected color. In an alternate embodiment, the author 102 can highlight or select the material and then change the style of the material to a predefined style understood by the “sanitization” macro. In addition, there can be one predefined style that signals the “sanitization” macro to insert a marker and a different predefined style that signals the “sanitization” macro to omit the marker.

In another embodiment of the present invention, instead of highlighting the restricted content to be removed, the author 102 can insert predefined tags into the draft DP 108 that are understood by the “sanitization” macro of step 208 in removing the restricted content. The author 102 can use one set of predetermined tags, e.g. &SSD#, &SE#, to insert a marker in the location where restricted content was removed and another set of predetermined tags, e.g. &SS#, &SE#, to omit the marker from the location where the restricted content was removed. The sets of tags can each have a starting tag, e.g. &SSD#, &SS#, and an ending tag, e.g. &SE#, or the same tag can be used to indicate both the starting and ending points. The requirements and guidelines for controlling the insertion of the tags depend on the specific configuration of the “sanitization” macro.

For example, a “sanitization” macro in step 208 can be configured to require that: the predetermined tags are to be inserted directly in front of, or directly behind the text of the restricted content; each starting tag must have a corresponding ending tag; and the tags cannot be nested. Furthermore, the author 102 can be required to apply the predetermined tags consistently within color or style formats or that the predetermined tags be in a specific style format, e.g. “DPText” or “Normal.”

In one embodiment of the present invention, the “sanitization” macro in step 208 maintains the text font characteristics, graphic, figure, equation, or table positioning of the removed content in the global export issued DP log 116 and adequately maintains the same position and orientation of the remaining material in and around the same in the global export issued DP 118. In another embodiment, the text, graphic, figure, equation, table, or material removed from the global export issued DP 118 does not maintain any font characteristics or positional information within the global export issued DP log 116.

When tagging or marking restricted content for removal, the author 102 has to consider the content of the restricted content under consideration and how that information, if required, will be transferred to a global engineer 122 for their use. The author 102 also has to consider the form of the information that resides in the global export issued DP log 116 and how it can be productively used and/or transferred when required. The removal of complete areas of text, graphics, equations, list items, etc. from the global export issued DP 118 produces a simple and easy to understand global export issued DP log 116. However, the complete removal of subject matter in the global export issued DP 118 can make interpretation of the meaning and design intent of the global export issued DP 118 very difficult. To provide continuity between the issued DP 114 and the global export issued DP 118, the author can leave the section headings and title intact in the global export issued DP 118 as a reference.

The author 102 can selectively remove restricted content in situations where the text, figures, tables, etc. can be removed without changing the context between the issued DP 114 and the global export issued DP 118. To assist the global engineer 122 in understanding the global export issued DP 118, the author 102 can have the marker “[deleted]” inserted into the global export issued DP 118 in those situations where the selective removal of restricted content changes the context of the global export issued DP 118 or renders the remaining material unreadable or grammatically incorrect. However, the author 102 has to also consider that by dividing up sentences and paragraphs with very small edits, a global export issued DP log 116 is created with entries that are difficult to understand. If a significant portion of a paragraph has restricted content, the author 102 can mark the entire paragraph for deletion for an easier to read and understand global export issued DP log 116 and global export issued DP 118.

In one embodiment of the present invention, the draft DP 108 can include one or more cross-references. Cross-references are used to automatically create hypertext links within the same document or to other documents. Captions within the draft DP 108 document, such as headings, figures, tables, equations, etc., can be cross-referenced in the document for easier use. The author 102 when marking the draft DP 108 has to match cross-references in the draft DP 108 with all equations, figures, and tables referenced to ensure that all restricted content is marked and removed from the draft DP 108.

In another embodiment of the present invention, some draft DPs 108 can use footnotes as references. The editing of footnotes by the author 102 can be classified into one of two situations: (1) removal of restricted content that includes a footnote reference; or (2) removal of restricted content in the footnote itself. To explicitly remove the contents of a footnote, the author 102 has to identify and highlight or tag the restricted content included within the footnote itself. The contents of the footnote will be omitted from the global export issued DP 118 and included in the global export issued DP log 116 as a separate entry.

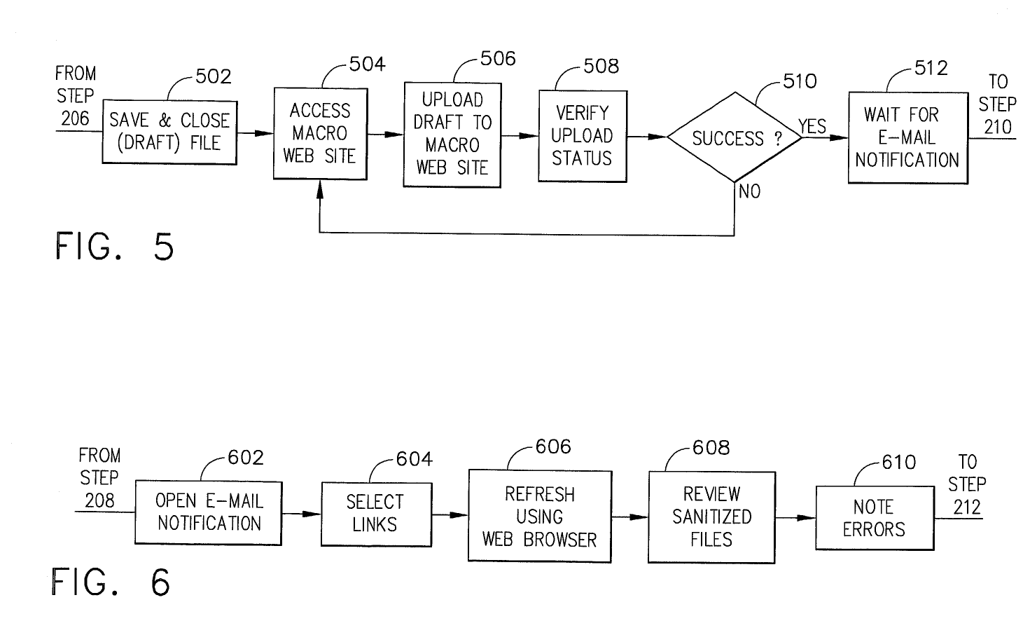

FIG. 5 illustrates a flow chart of the process for executing the sanitization macro or routine in step 208 of FIG. 2 on the marked or tagged draft DP 108 to obtain the global export issued DP log 116 and the global export issued DP 118 or the sanitized draft DP 110 and the sanitized draft DP log 112. To begin, after the document has been tagged to remove restricted content in step 206 using the procedure in FIG. 4, the author 102 saves and closes the file with the draft DP 108 in step 502. In step 504, the author 102 accesses a web site with macros or routines for sanitizing the marked or tagged draft DP 108. The author 102 uploads the tagged draft DP 108 to the web site in step 506 and confirms the successful upload of the draft DP 108 in step 508. In step 506, author 102 can upload the draft DP 108 to either a draft mode or approved mode of the sanitization macro. In draft mode, the sanitization macro is setup or configured to keep the most current version of the sanitized draft DP 110. An upload to the web site overwrites any previous versions of the sanitized draft DP 110. However, in the approved mode, version control is maintained by the sanitization macro for issued DPs 114, global export issued DP logs 116 and global export issued DPs 118 that have been approved and stored in the database. In step 510, the author 102 determines if the sanitization macro executed successfully. If the sanitization macro has executed successfully, the author 102 has to then wait for a e-mail notification in step 512, otherwise, the author returns to step 504 and accesses the macro web site.

Notification of macro completion status is e-mailed in step 512 back to the author 102 who uploaded the marked or tagged draft DP 108 in step 506. In one embodiment, the sanitization macro operates on a timed retrieval cycle (e.g. every three minutes). The sanitization macro will process, as a batch, all draft DPs 108 that are waiting in a queue at the start of a cycle. Thus, if there are many draft DPs 108 waiting in the queue for processing, the entire batch is processed until completion, and then e-mail notifications of completion are sent out. For example, a single global export issued DP 118 can take around 5-10 minutes to create from a marked or tagged draft DP 108 having 50 pages and 30-40 data tags. In another embodiment of the present invention, the sanitization macro can process each draft DP 108, individually, as received.

Proper execution of the sanitization macro relies on proper insertion of the data tags or on the proper marking or designation of document styles. In one embodiment of the invention, the sanitization macro processes the data tags or style markers, in a serial fashion, from left-to-right, top-to-bottom through the document.

There are several error indicators that can occur during the processing of the sanitization macro. Once an error is corrected in the draft DP 108, the author 102 has to reprocess the draft DP 108 to create another sanitized draft DP 110 and the sanitized draft DP log 112. The most common sources of sanitization macro processing errors caused by draft DP 108 document editing are incorrect insertion of data tags around restricted information content.

FIG. 6 illustrates a flow chart of the process of verifying the removal of restricted content in step 210 of FIG. 2. To begin, after the sanitization macro or routine has been processed on the draft DP 108 in step 208 using the procedure in FIG. 5, the author 102 opens an e-mail notification of the completion of sanitization processing in step 602. Next, in step 604, the author 102 selects the appropriate links or URLs to be linked to a web page with the sanitized files. Depending on the web browser settings, the author 102 may then refresh the web page using the web browser in step 606 to view the latest changes. In step 608, the author 102 reviews the sanitized files for completeness and understanding. After reviewing the files in step 608, the author notes any errors, corrections or other changes to the sanitized files in step 610. If there are not any errors or changes to the sanitized files, then the draft DP 108, the sanitized draft DP 110 and the sanitized draft DP log 112 can be uploaded for review by reviewers 104 or approval by the approver 106.

Preferably, the author 102 reads the global export issued DP 118 or the sanitized draft DP 110 without reference to the global export issued DP log 116 or the sanitized draft DP log 112, being cognizant of the fact that the external or global engineering resources can only have access to the global export issued DP 118. The author 102 can also note any areas where interpretation of the global export issued DP 118 or the sanitized draft DP 110 intent would be difficult, misleading, or incorrect from the draft DP 108. In addition, the author 102 can verify that any restricted information that is significant to the intent of the draft DP 108 and removed to the sanitized draft DP log 112 or global export issued DP log 116 can easily be identified for expedient transfer to a global resource if necessary. The author 102 may have to readjust the data tags or markers to include a greater segment of information solely for this purpose. Finally, the author 102 can review the sanitized files for correct “remaining” content and systematic editing and processing errors.

In one embodiment of the present invention, as a method of processing web pages for off-line viewing and for increasing the speed at which web pages load, the contents of the previously viewed web pages are stored locally on the author's computer as cache items. By default, the web pages stored locally as cache items are displayed in the browser when a link in the e-mail notification is activated by the author 102.

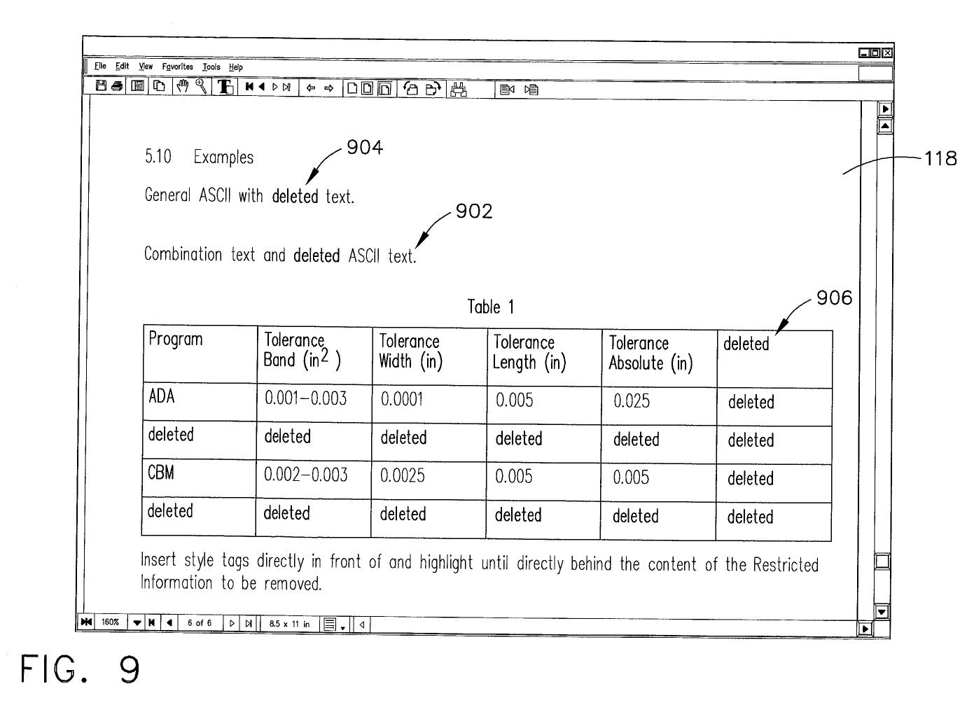

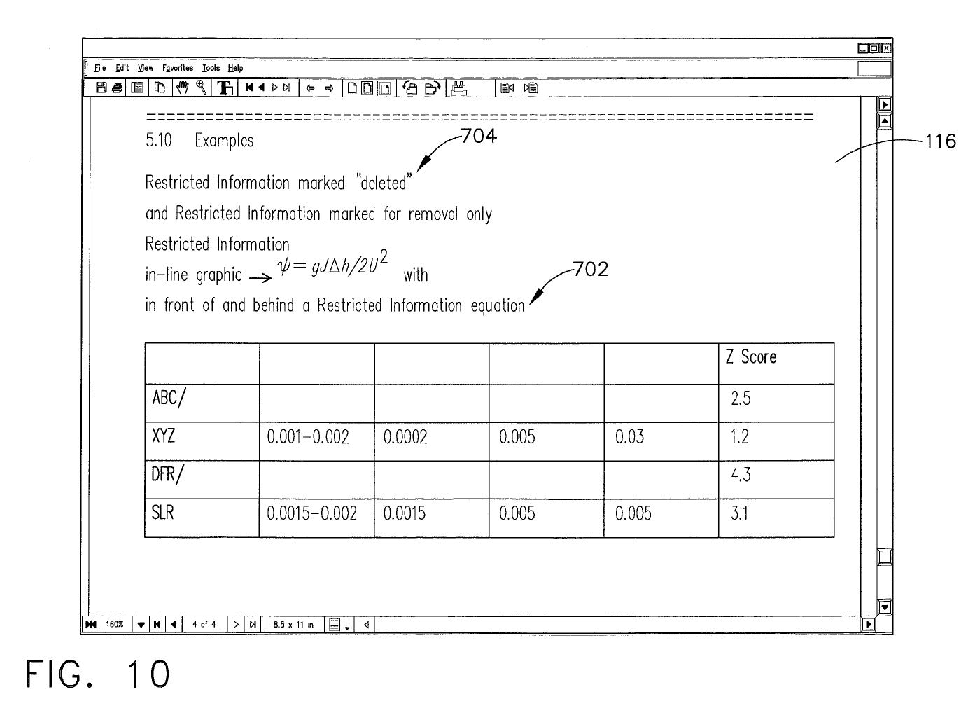

FIG. 7 illustrates a draft DP 108 that has been marked or tagged in accordance with step 404-408. The draft DP 108 in FIG. 7 has several sections of text and graphics 702 and 704 that have been marked or tagged. Section 702 has been marked in a style that corresponds to the removal of content from the document without the insertion of a marker 906 (see FIG. 9). The content included in section 702 is the text that has been removed in material removal section 902 (see FIG. 9). Section 704 has different marking style from section 702. Section 704 has been marked in a style that corresponds to the removal of content from the document with the insertion of marker 906. The content included in section 704 is the content that has been removed in material removal section 904 (see FIG. 9) and marked with marker 906. Similar marking of content is shown in FIG. 7 through FIG. 10 representing removal of content in graphics and content included within table cells.

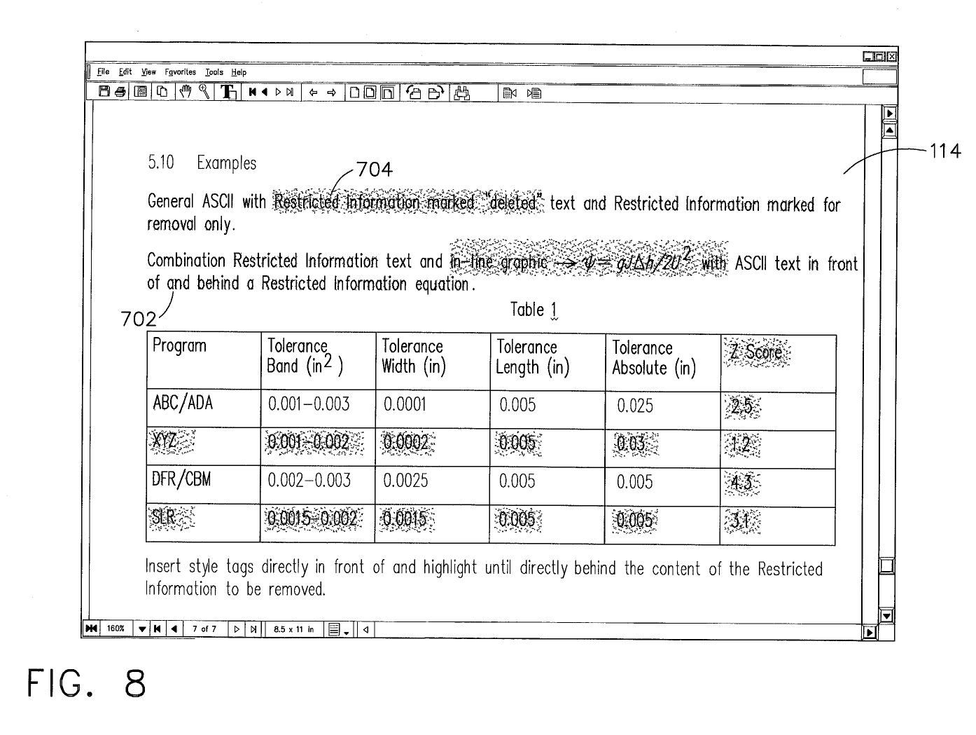

FIG. 8 illustrates an issued DP 114 that has been approved and uploaded to the database for viewing by authorized internal users 120. The issued DP 114 is similar to the draft DP 108 shown in FIG. 7 in that the issued DP 114 shown in FIG. 8 also has the marked or tagged sections 702 and 704. As discussed above, the issued DP 114 preferably includes a complete description and listing of all information. The information in the issued DP 114 is highlighted or marked substantially identical to that in the draft DP 108 so that an authorized internal user 120 can quickly determine the material and information that is not going to be provided to the authorized global source 122 in the global export issued DP 118.

FIG. 9 illustrates a global export issued DP 118 that can be viewed by an authorized global engineer or external source 122. The global export issued DP 118 is a sanitized version of the issued DP 114 shown in FIG. 8. In the global export issued DP 118 shown in FIG. 9, restricted content included in sections 702 and 704 has been removed from the document at locations 902 and 904. At document removal location 904, a marker 906 indicating the removal of material from the global export issued DP 118 is displayed. The marker 906 in FIG. 9 is “[deleted],” however any type of marker can be used to indicate the removal of material from the global export issued DP 118.

FIG. 10 illustrates the global export issued DP log 116 that can be viewed by authorized internal users 120 and, after compliance with appropriate security and export control provisions, specific sections or portions of the global export issued DP log 116 can be transferred or viewed by authorized external sources or global engineers 122. The global export issued DP log 116 includes all the material that was marked for removal from the issued DP 114. The material included in the global export issued DP log 116 can maintain and utilize similar positioning and heading information as was used in the issued DP 114 to make the global export issued DP log 116 easier to understand and use in conjunction with the global export issued DP 118.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of generating a sanitized document, the method comprising the steps of:
obtaining a document, the document including a plurality of types of information;
reviewing the document to identify a preselected type of information in the document;
marking the identified preselected type of information in the document to generate a marked document, wherein the marked identified preselected type of information in the marked document is distinguishable from other types of information in the marked document;
executing an application on the marked document to generate a sanitized document and a log file, wherein the marked identified preselected type of information is removed from the sanitized document, and is included in the log file; and
storing the marked document, the sanitized document and the log file in a database, the marked document, the sanitized document and the log file stored in the database being accessible by a plurality of users to provide to an external source.

2. The method of claim 1 wherein the step of marking the identified preselected type of information in the document further comprises the steps of:
locating a starting point and an ending point of a portion of the identified preselected type of information in the document;
indicating, in the document, the starting point and the ending point for the portion of the identified preselected type of information in the document; and
repeating the steps of locating a starting point and an ending point and indicating, in the document, the starting point and the ending point until all portions of the identified preselected type of information in the document have been identified.

3. The method of claim 2 wherein the step of indicating, in the document, the starting point and the ending point further comprises the steps of:
selecting the portion of the identified preselected type of information in the document between the starting point and ending point; and
at least one of the steps of:
highlighting the selected portion of the identified preselected type of information in the document in a preselected color; and
changing a style of the selected portion of the identified preselected type of information in the document to a preselected style.

4. The method of claim 2 wherein the step of indicating, in the document, the starting point and the ending point further comprises the steps of:
inserting a first tag at the starting point of the portion of the identified preselected type of information in the document; and
inserting a second tag at the ending point of the portion of the identified preselected type of information in the document.

5. The method of claim 2 wherein the step of indicating, in the document, the starting point and the ending point further comprises one of the steps of:
indicating the starting point and ending point of the portion of the identified preselected type of information in the document with a first indication style, wherein the application, in response to the first indication style, inserts a marker in the sanitized document corresponding to the portion of the identified preselected type of information in the document; and
indicating the starting point and ending point of the portion of the identified preselected type of information in the document with a second indication style, wherein the application, in response to the second indication style, omits the marker in the sanitized document corresponding to the portion of the identified preselected type of information in the document.

6. The method of claim 1 wherein the step of reviewing the document to identify a preselected type of information in the document further comprises at least one of the steps of:
viewing documentation related to the identification of the preselected type of information, the documentation including a list of preselected terms, other documents and other tools; and
performing a search on the document, wherein the step of performing a search on the document further comprises the steps of:
executing a search application on the document to search for a keyword in the document;
identifying instances of the keyword in the document; and
reviewing the document for the identified instances of the keyword in the document.

7. The method of claim 1 further comprising the steps of:
verifying the preselected type of information has been removed from the sanitized document before the step of storing the marked document, the sanitized document and the log file in a database; and
repeating the steps of reviewing the document, marking the identified preselected type of information in the document and executing an application to generate a sanitized document and a log file from the marked document until all of the preselected type of information has been verified as being removed from the sanitized document.

8. The method of claim 7 wherein:
the step of obtaining a document further comprises one of the steps of:
creating a new document; and
downloading a previously created document;
the step of executing an application on the marked document to generate a sanitized document and a log file, further comprises the steps of:
accessing a preselected web site, wherein the application is included in the preselected web site; and
uploading the marked document to the preselected web site to be executed on by the application; and
the step of verifying the preselected type of information has been removed from the sanitized document, further comprises the steps of:
opening a notification from the application that the sanitized document and the log file have been generated, wherein the notification includes links to the sanitized document and the log file;
accessing the sanitized document and the log file using the links;
reviewing the sanitized document and the log file for the preselected type of information; and
indicating any preselected type of information included in the sanitized document.

9. A computer program product embodied on a computer readable medium and executable by a computer for generating a sanitized document, the computer program product comprising computer instructions for executing the steps of:
obtaining a draft document, the draft document including restricted information and unrestricted information;
reviewing the draft document to identify the restricted information in the draft document;
tagging the identified restricted information in the draft document to generate a tagged document, wherein the tagged restricted information in the tagged document is distinguishable from the unrestricted information and untagged restricted information in the tagged document;
processing the tagged document to generate a sanitized document and a log file from the tagged document, the sanitized document including the unrestricted information and untagged restricted information, and the log file including the tagged restricted information; and
storing the tagged document, the sanitized document and the log file in a database, the tagged document, the sanitized document and the log file stored in the database being accessible by a plurality of users to provide to an external source.

10. The computer program product of claim 9 wherein the step of tagging the identified restricted information in the draft document further comprises the steps of:
locating a starting point and an ending point of a portion of the identified restricted information in the draft document;
indicating, in the draft document, the starting point and the ending point for the portion of the identified restricted information in the draft document;
repeating the steps of locating a starting point and an ending point and indicating, in the draft document, the starting point and the ending point until all portions of the identified restricted information in the draft document have been indicated.

11. The computer program product of claim 10 wherein the step of indicating, in the draft document, the starting point and the ending point further comprises the steps of:
selecting the portion of the identified restricted information in the draft document between the starting point and ending point; and
at least one of the steps of:
highlighting the selected portion of the identified restricted information in the draft document in a preselected color; and
changing a style of the selected portion of the identified restricted information in the draft document to a preselected style.

12. The computer program product of claim 10 wherein the step of indicating, in the draft document, the starting point and the ending point further comprises the steps of:
inserting a first tag at the starting point of the portion of the identified restricted information in the draft document; and
inserting a second tag at the ending point of the portion of the identified restricted information in the draft document.

13. The computer program product of claim 10 wherein the step of indicating, in the draft document, the starting point and the ending point further comprises one of the steps of:
indicating the starting point and ending point of the portion of the identified restricted information in the draft document with a first indication style, the first indication style having a marker inserted into the sanitized document at the location of the portion of the identified restricted information during the step of processing the tagged document to generate a sanitized document; and
indicating the starting point and ending point of the portion of the identified restricted information in the draft document with a second indication style, the second indication style having a marker omitted from the sanitized document at the location of the portion of the identified restricted information during the step of processing the tagged document to generate a sanitized document.

14. The computer program product of claim 13 wherein the step of processing the tagged document to generate a sanitized document and a log file from the tagged document, further comprises the steps of:
parsing the tagged document for an indicated portion of the identified restricted information in the draft document;
removing the parsed portion of the identified restricted information in the draft document from the sanitized document;
inserting the marker in the sanitized document in response to the parsed portion of the identified restricted information in the draft document being in the first indication style;
omitting the marker in the sanitized document in response to the parsed portion of the identified restricted information in the draft document being in the second indication style; and
inserting the parsed portion of the identified restricted information in the draft document into the log file.

15. The computer program product of claim 9 wherein:
the step of obtaining a draft document further comprises one of the steps of:
creating a new document; and
downloading a previously created document; and
the step of reviewing the draft document to identify restricted information in the draft document further comprises at least one of the steps of:
viewing documentation related to the identification of restricted information, the documentation including a list of restricted terms, other documents and other tools; and
performing a search on the draft document, wherein the step of performing a search on the draft document further comprises the steps of:
selecting a keyword from the list of restricted terms;
processing the draft document to search for the selected keyword;
highlighting instances of the selected keyword in the draft document; and
reviewing the draft document for the highlighted instances of the selected keyword.

16. A system for generating a sanitized document, the system comprising:
a server computer, the server computer comprising a storage device and a processor;
a database, the database being accessible by the server computer;
a sanitization application to remove preselected information from a document for an external source, the sanitization application being stored in the storage device of the server computer, the sanitization application further comprising:
means for editing the document to designate the preselected information in the document;
means for generating an issued document from the edited document, the issued document being stored in the database and including both marked preselected information and other information;
means for generating a sanitized document from the edited document, the sanitized document being stored in the database and omitting the marked preselected information;
means for generating a log file from the edited document, the log file being stored in the database and including the marked preselected information; and
means for retrieving the sanitized document and the log file from the database, the retrieved sanitized document and log file being providable to an external source; and
at least one client computer in communication with said server computer, the sanitization application being accessible on said at least one client computer.

17. The system of claim 16 wherein the means for editing the document further comprises:
means for selecting a portion of the preselected information in the document; and
means for marking the selected portion of the preselected information in the document for removal from the sanitized document.

18. The system of claim 17 wherein the means for marking the selected portion of the preselected information in the document further comprises at least one of:
means for highlighting the selected portion of the preselected information in the document in at least one preselected color, each preselected color controlling specific removal of the selected portion of the preselected information in the document from the sanitized document;
means for changing a style of the selected portion of the preselected information in the document to at least one preselected style, each preselected style controlling specific removal of the selected portion of the preselected information in the document from the sanitized document; and
means for inserting a pair of tags around each end of the selected portion of the preselected information in the document, each pair of tags controlling specific removal of the selected portion of the preselected information in the document from the sanitized document.

19. The system of claim 18 wherein:
the at least one preselected color comprises a first preselected color and a second preselected color, the first preselected color signaling the means for generating the sanitized document to insert a marker in the sanitized document for the selected portion of the preselected information in the document and the second preselected color signaling the means for generating the sanitized document to omit the marker in the sanitized document for the selected portion of the preselected information in the document;
the at least one preselected style comprises a first preselected style and a second preselected style, the first preselected style signaling the means for generating the sanitized document to insert a marker in the sanitized document for the selected portion of the preselected information in the document and the second preselected style signaling the means for generating the sanitized document to omit the marker in the sanitized document for the selected portion of the preselected information in the document; and
the pair of tags comprises a first pair of tags and a second pair of tags, the first pair of tags signals the means for generating the sanitized document to insert a marker in the sanitized document for the selected portion of the preselected information in the document and the second pair of tags signals the means for generating the sanitized document to omit the marker in the sanitized document for the selected portion of the preselected information in the document.

20. The system of claim 16 wherein:
the at least one client computer and the server computer are connected by an Intranet;
the means for generating an issued document further comprises means for generating a revised issued document from an issued document, the revised issued document being stored in the database with the issued document;
the sanitization application further comprises means for controlling access, by a user, to documents in the database based on predetermined access rights of that user, the predetermined access rights limiting a user to documents in the database having a security level within the predetermined access rights of that user;
the preselected information includes restricted information, technical data and proprietary information; and
the means for editing the document further comprises:
means for creating a new document;
means for a loading a previously created document from the database;
means for accessing reference material to assist in editing the document, the reference material including a list of restricted terms related to the preselected information, other documents and other tools; and
means for performing a keyword search on the document to identify keywords included in the document.
